(19) United States
(12) Patent Application Publication
(10) Pub. No.: US 2012/0109685 A1
(43) Pub. Date: May 3, 2012

(54) LINKING HEALTH RECORDS

(75) Inventors: Brian R. Carter, Kansas City, MO (US); Robert Scott Ackerson, Kansas City, MO (US)

(73) Assignee: CERNER INNOVATION, INC., Overland Park, KS (US)

(21) Appl. No.: 12/916,736

(22) Filed: Nov. 1, 2010

(51) Int. Cl. G06Q 50/00; G06Q 10/00

(52) U.S. Cl. 705/3

(57) ABSTRACT

Methods, systems, and computer storage media are provided for linking health records. A patient document may be received from a provider and confirmed by a patient to be linked to their health record. To confirm a document, a connection between a provider and a health record is established. Once the connection is initially established between the provider and the health record, subsequent patient documents received from the approved provider may be automatically linked to the health record. Connections may be established with multiple providers such that a single health record includes patient documents for multiple patient encounters with different providers.

### BACKGROUND

With the growing complexity of the healthcare system and increasing interactions between patients with multiple healthcare providers, access to one's medical records may be a cause of concern for many individuals. Today, patients typically have contact with one or more healthcare providers. When numerous healthcare providers are involved in the care of a patient, a complete health record may not be accessible in a centralized location and, further, may not be accessible to a patient at all. For instance, a patient's primary care clinician may have access to records for an initial clinical contact whereby the patient was referred to a specialist while the specialist may have access to records including additional clinical data. The patient treated by their primary care clinician and the specialist may need to contact both providers to obtain access to their medical records for each clinical encounter.

Electronic integration of a patient's medical records into a central location accessible by one or both of the patient and the providers is a daunting task for many reasons. Initially, privacy is at the forefront of healthcare and requires safeguards regarding the patients, the providers, the medical records, and the like. Additionally, a variety of healthcare providers may utilize disparate systems and may distribute data according to varying standards. Accordingly, there currently exists a gap between patients and/or providers and a centralized health record.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to creating a centralized electronic patient health record by linking health records. A patient document for a patient may be received from a provider. Upon receiving a patient document, the patient document may be verified. Typically, the patient document may include patient contact information such that the patient may be prompted to verify the patient document using the patient contact information. Upon verification of the patient document, the patient document may be stored in the patient's health record. Patient documents from various healthcare providers may be verified and stored in the patient's health record such that the health record may be a complete health record, avoiding gaps in treatment found in current health records.

Accordingly, in one aspect, the present invention is directed to one or more computer storage media storing computer-useable instructions that, when used by one or more computing devices, cause the one or more computing devices to perform a method. The method includes receiving a patient document including patient data and clinical data. A provider associated with the patient document is identified and a prompt is communicated to the patient to verify the patient document. Input is received from the patient. The input may be patient information. A determination is made that the patient input correlates with the patient data of the patient document and the patient document is stored in a health record for the patient.

In another aspect, the present invention is directed to one or more computer storage media storing computer-useable instructions that, when used by one or more computing devices, cause the one or more computing devices to perform a method. The method includes receiving a patient document including patient data and clinical data and identifying a provider associated therewith. The patient document is verified by communicating a prompt to the patient to verify the patient document, receiving patient input including identifying information for the patient, and determining whether the patient input correlates with the patient data from the patient document. Upon determining that the identifying information from the patient input correlates with the patient data from the patient document, determining whether a connection exists between the provider and a health record of the patient. Upon determining a connection does not exist, establishing a connection and storing the patient document in the health record.

In yet another aspect, the present invention is directed to one or more computer storage media storing computer-useable instructions that, when used by one or more computing devices, cause the one or more computing devices to perform a method. The method includes receiving a first patient document and identifying a first provider associated therewith. A prompt is communicated to the patient to associate the first patient document with a health record for the patient. A first patient input is received and a determination is made whether a connection exists between the first provider and the patient's health record. Upon determining that a connection does not exist, a connection is established and the first patient document is stored in the patient's health record. A second patient document is received and a second provider associated therewith is identified. A prompt is communicated to the patient to associate the second document with the patient's health record. A second patient input is received. A determination is made whether a connection exists between the second provider and the patient's health record. Upon determining a connection does not exist, establishing a connection and storing the second patient document in the patient's health record.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is an exemplary system architecture suitable to implement embodiments of the present invention;

FIG. 3 is a screenshot illustrating an exemplary connection prompt interface, in accordance with embodiments of the present invention;

FIG. 4 is a screenshot illustrating an exemplary health record account summary interface, in accordance with an embodiment of the present invention;

FIG. 5 is a screenshot illustrating an exemplary health record interface, in accordance with an embodiment of the present invention; and

FIG. 6 is a flow diagram illustrating an exemplary method for linking health records, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention provide for systems, methods, and computer storage media for creating a comprehensive health record. A patient document for a patient may be received from a provider. Typically, the patient document includes patient contact information such that the patient may be invited to verify the patient document. For example, the patient may have listed an electronic mail (e-mail) address during registration with the provider. Accordingly, a prompt may be sent to the given e-mail address of the patient to verify the patient document. Upon verification of the patient document, the patient document may be stored in the patient's health record. Patient documents from a variety of providers may be verified and stored in the patient's health record. Accordingly, the health record may include a plurality of patient documents from a plurality of providers. By verifying each patient document for a patient's treatment, the health record may be complete and aid in avoiding gaps in treatment.

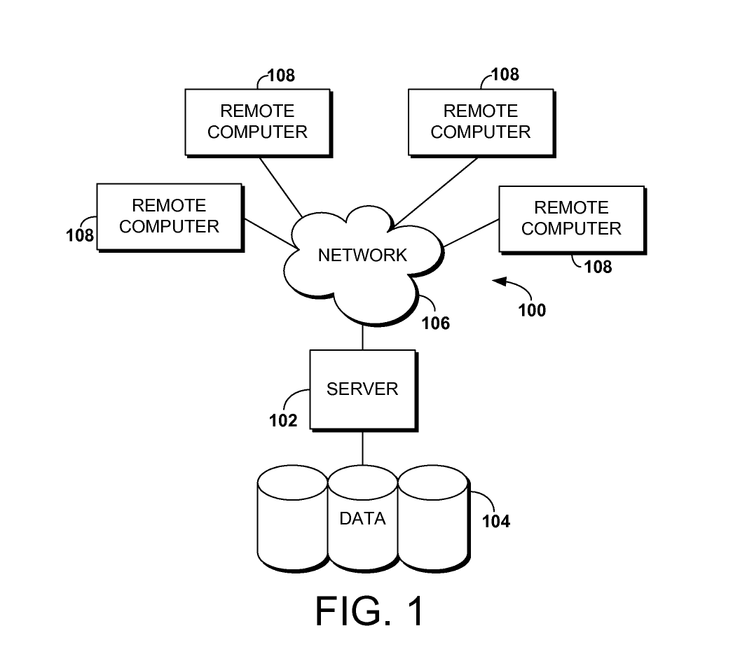

Having briefly described embodiments of the present invention, an exemplary operating environment suitable for use in implementing embodiments of the present invention is described below. Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer-readable media, for instance, database cluster 104. Computer-readable media can be any available media that may be accessed by server 102, and includes volatile and nonvolatile media, as well as removable and non-removable media. By way of example, and not limitation, computer-readable media may include computer storage media and communication media. Computer storage media may include, without limitation, volatile and nonvolatile media, as well as removable and nonremovable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 104, provide storage of computer-readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home healthcare environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 108 may also be physically located in nontraditional medical care environments so that the entire healthcare community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

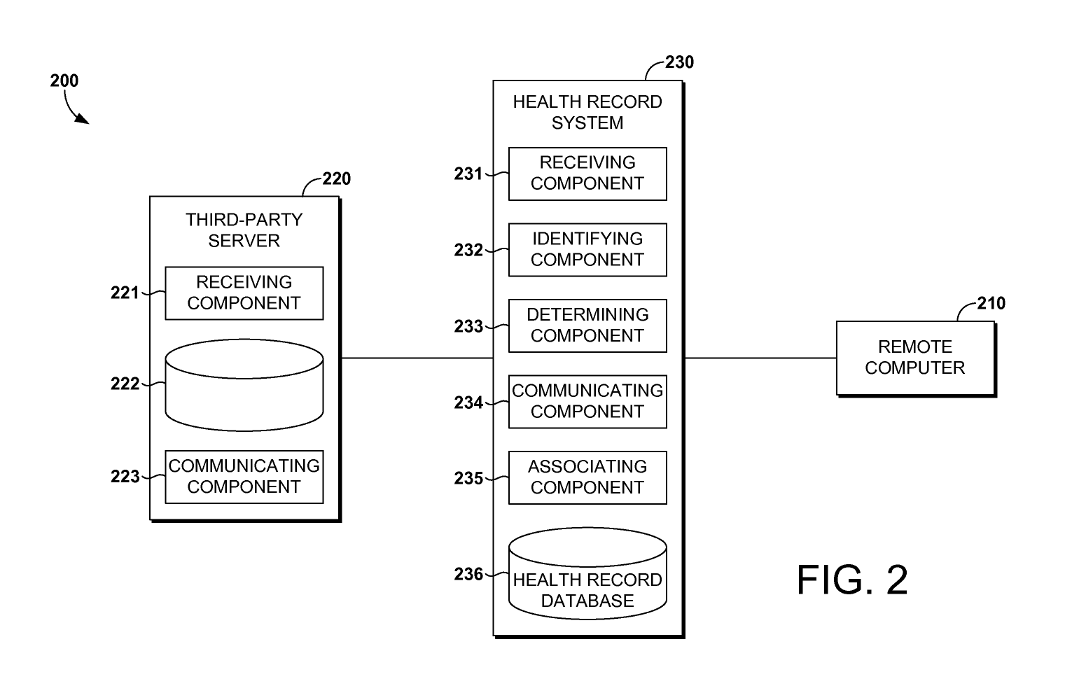

Turning to FIG. 2, an architectural framework 200 is shown for linking patient health records. This architectural framework 200 may operate, for instance, within the context of the exemplary medical information system 100 of FIG. 1. The system of FIG. 2 includes a remote computer 210, a third-party server 220, and a health record system 230. Other components not shown here may also be used to carry out aspects of the present invention. These components not shown may include, for example, a network that is used to communicate data from each component shown in FIG. 2, and a second third-party server associated with a healthcare provider different than that of the illustrated third-party server 220 shown in FIG. 2. Further, several components shown in FIG. 2 may be combined into a single component although shown separately in FIG. 2. Alternatively, components, such as the third-party server 220, although shown as a single component, may actually be two or more devices.

The third-party server 220 includes a receiving component 221, a clinical database 222, and a communicating component 223. Each component of the third-party server 220 may assist in receiving, storing, communicating, or the like, information relevant to link documents to a patient's health record. The third-party server 220 may be associated with a healthcare provider. Healthcare providers may include, but are not limited to, clinicians, hospitals, clinics, pharmacies, laboratories, and the like. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like.

Typically, during and/or after a patient encounter, a patient document/record is generated. A patient document, as used herein, refers generally to a healthcare record for a patient that includes patient data and clinical data. Patient data may include, but is not limited to, patient information including a patient name, a patient date of birth, an address of a patient, an electronic mail (e-mail) address, or the like. Patient data may further include demographic information of a patient such as a sex of the patient, an age of a patient, or the like. Clinical data may include, but is not limited to, a health history of the patient, a diagnosis, a treatment, a family history, insurance information, an immunization record, medications, test results, allergies, reactions, procedures performed, social history, advance directives, alerts, vitals, and the like.

In embodiments, the patient document is a continuity of care document (CCD). A CCD, as used herein, refers generally to a patient document for a specific patient encounter. A CCD may be generated for each patient encounter. For example, if Patient John is examined by Clinician A on Monday, a CCD for that patient encounter may be generated. Additionally, if Patient John sees Clinician B on Wednesday, a different CCD for the encounter with Clinician B may be generated. A CCD may include data for multiple patient encounters, as well. As CCD's are typically episodic, meaning that the CCD includes data for a single patient encounter, the complete CCD is typically generated at the end of the patient encounter, or when the patient's chart is closed.

Returning to FIG. 2, during a patient encounter, data is collected and is received by the receiving component 221. The receiving component 221 is configured to receive data input into the third-party server 220. The data input may be patient data, clinical data, a patient document, or the like. In embodiments, the data received at the receiving component 221 includes, at least, patient contact information, such as a patient's e-mail address. The e-mail address may be provided by the patient at the time of admission, discharge, transfer, or the like. In an embodiment, patient contact information, such as an e-mail address, is collected via an information card or a questionnaire inquiring whether the patient would like to link documents to a health record.

Upon receiving the data, the receiving component 221 communicates the data to the clinical database 222. The clinical database 222 is configured to receive data to be stored. The clinical database 222 may include, but is not limited to, patient documents, patient data, clinical data, clinician information, or the like. In embodiments, the receiving component 221 communicates data to the clinical database 222 when the patient chart is not yet closed so the CCD has not yet been generated.

Once the patient document is generated, the clinical database 222 may communicate the patient document to the communicating component 223. Alternatively, the receiving component 221 may communicate the patient document to the communicating component 223. For example, the receiving component 221 may directly communicate the patient document to the communicating component 223 if, for instance, the patient's chart is closed and the patient document is complete when received by the receiving component 221.

The communicating component 223 may communicate patient documents from the third-party server 220. The patient documents may be communicated by the communicating component 223 at any time. In embodiments, the communicating component 223 does not communicate a patient document until the patient's chart is closed, thus, completing the patient document.

The patient document may be communicated in any format known to one of ordinary skill in the art. For instance, the patient document may be communicated in such a way that a header identifies the patient document and a body/payload identifies contents of the patient document. In embodiments, the patient document itself is communicated without generating a message. The patient document may be communicated to a secured web service. In embodiments, the patient document is communicated to a health record system 230.

The health record system 230 may be any computing device capable of linking patient documents. A health record system may take on a variety of forms, such as a server or any other device that enables health record linking capabilities as described herein. The health record system 230 includes a receiving component 231, an identifying component 232, a determining component 233, a communicating component 234, an associating component 235, and a health record database 236.

The receiving component 231 may receive and/or communicate patient documents or information related thereto. In embodiments, patient documents are received at the receiving component 231 from the third-party server 220. As previously mentioned, patient documents themselves may be communicated from the third-party server 220. In other words, the actual patient document is communicated and received rather than a message indicating a patient document therein. As such, the architectural framework 200 is able to utilize information from the actual patient document and resources are not expended to create messages to communicate patient documents.

Upon receiving the patient document, the identifying component 232 may identify data associated with the patient document. In embodiments, the identifying component 232 identifies a healthcare provider associated with the patient document. In embodiments, the identifying component 232 is identifying data directly from the patient document itself, since a message may not have been generated to communicate the patient data.

Once a provider is identified as being associated with a received patient document, the determining component 233 determines whether a health record exists for the patient. A health record must exist in order for a provider to contribute patient documents to the health record. Upon determining that a health record does not exist for a patient, the patient is prompted to create a health record account. Upon determining that a health record does exist for a patient, the patient is prompted to log-in to their health record. When the patient has an existing health record account with the health record system 230, the patient may simply enter log-in credentials such as, for example, a username and password, to access their health record. Since the health record is accessed and/or created by a user using log-in credentials, the user is able to receive prompts at a variety of locations for a single health record. For example, a user may give a different e-mail address to each provider that the user encounters and a prompt will be sent to the given e-mail address with an associated patient document for the corresponding provider. Even though the patient documents for different providers are sent to different e-mail addresses, the user is still able to log-in to a single health record and confirm that the patient documents should be associated with the same health record.

The prompts may be communicated to the patient based on contact information from the patient document. For instance, the patient's e-mail address may be used to communicate the prompt. The prompt may include, but is not limited to, a provider identifier that identifies a provider associated with the patient document. In embodiments, the prompts are e-mails communicated to the patient. In additional embodiments, the prompts are communicated by the communicating component 234 of the health record system 230 to the remote computer 210.

In further embodiments, the patient may be prompted to verify the patient document once the patient has already logged into their health record account. For example, a user may log into their health record account and be prompted with a notification that a patient document is pending verification. Thus, prompts may be communicated to patients external to their health record account (e.g., e-mail prompts) or internally (e.g., prompts displayed to a user upon logging into a health record account).

Once a health record account is created and/or a user has logged in to their health record, the determining component determines whether a connection exists between the provider of the patient document and a health record associated with the patient of the patient document. A connection exists between a provider and a patient's health record when a patient has previously confirmed that the provider may contribute patient documents to the patient's health record. Connections may be made between the health record and multiple providers such that patient documents from different providers may be associated with the patient's health record.

A provider may be confirmed to contribute to a patient's health record via a connection prompt. A connection prompt may be displayed to a patient once they create their health account or once they log in to an existing health account. The connection prompt may include, but is not limited to, a unique key identifying a particular combination of a provider identifier and a patient identifier that identifies both a provider associated with the patient document and a patient record from the third-party server 220 that the subject patient document is associated therewith. The connection prompt may alert the patient that a specific provider is attempting to send a patient document to the patient's health record account and request that the patient establish a connection between the provider and the patient's health record.

If a user has been determined to have both an existing health record account and a connection between their health record and a provider, a prompt is communicated to the user to notify the user that a patient document is available in their existing health record. A connection prompt is not necessary since a connection already exists between the healthcare provider and the health record.

When the user does not have an existing connection between a provider and their health record, a connection prompt may be communicated to the remote computer 210. The connection may be established by correlating input from a patient with data from the patient document. For example, a patient may be queried to input their last name, their date of birth, and their zip code to establish a connection with a provider. The patient input may be compared to data of the patient document to verify the patient input is correct.

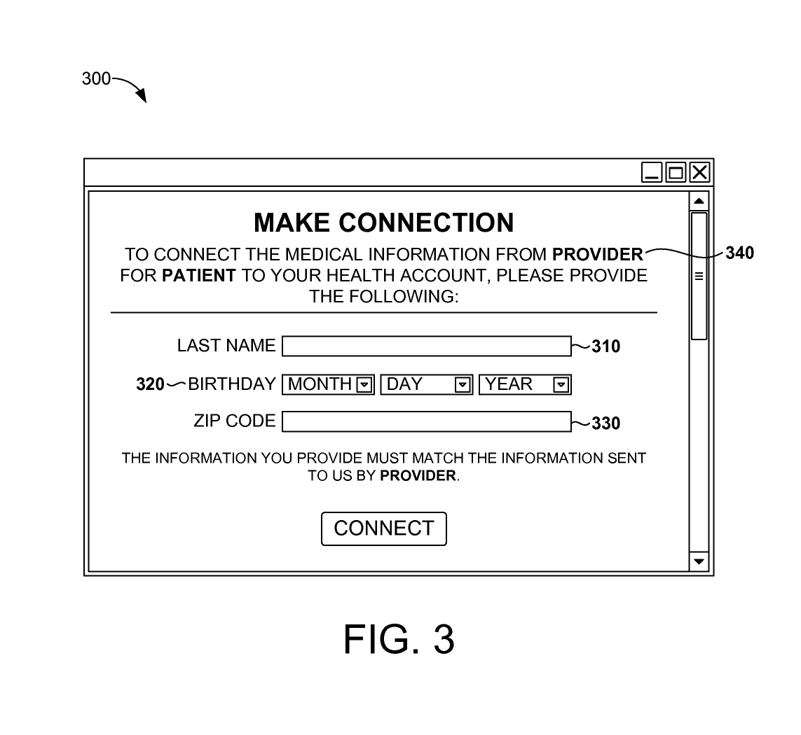

An exemplary connection input interface 300 is illustrated in FIG. 3. The connection input interface 300 may include, but is not limited to, a last name input area 310, a date of birth input area 320, and a zip code input area 330. The connection input interface 300 may further identify a provider associated with the patient document as indicated by a provider identifier 340. In embodiments, the connection input interface 300 is displayed to establish a connection between a health record and a provider for the first time. Once the connection is established, patient documents submitted from the previously confirmed provider may be automatically associated with the patient's health record upon log-in of the health record by a user. In alternative embodiments, the connection input interface 300 is displayed each time a patient document is received from a provider, regardless of whether a connection exists between the provider and the patient's health record.

The information provided by the user in the connection input interface 300 must match the information from the patient document to be accepted. If the patient input does not match the information from the patient document, no connection is established. If the patient input does match the information from the patient document, a connection is established between the provider and the patient's health record and the associating component 235 may associate the patient document with the patient's health record.

Returning to FIG. 2, the associating component 235 may associate patient documents with a patient's health record from the health record database 236 once the patient has created a connection between the provider and the health record and the patient document information is matched to the patient input. The health record database 236 may include health records for a plurality of patients. The health records may further include patient documents from a plurality of providers. Once the patient document is associated with the health record, the patient document is accessible within the health record.

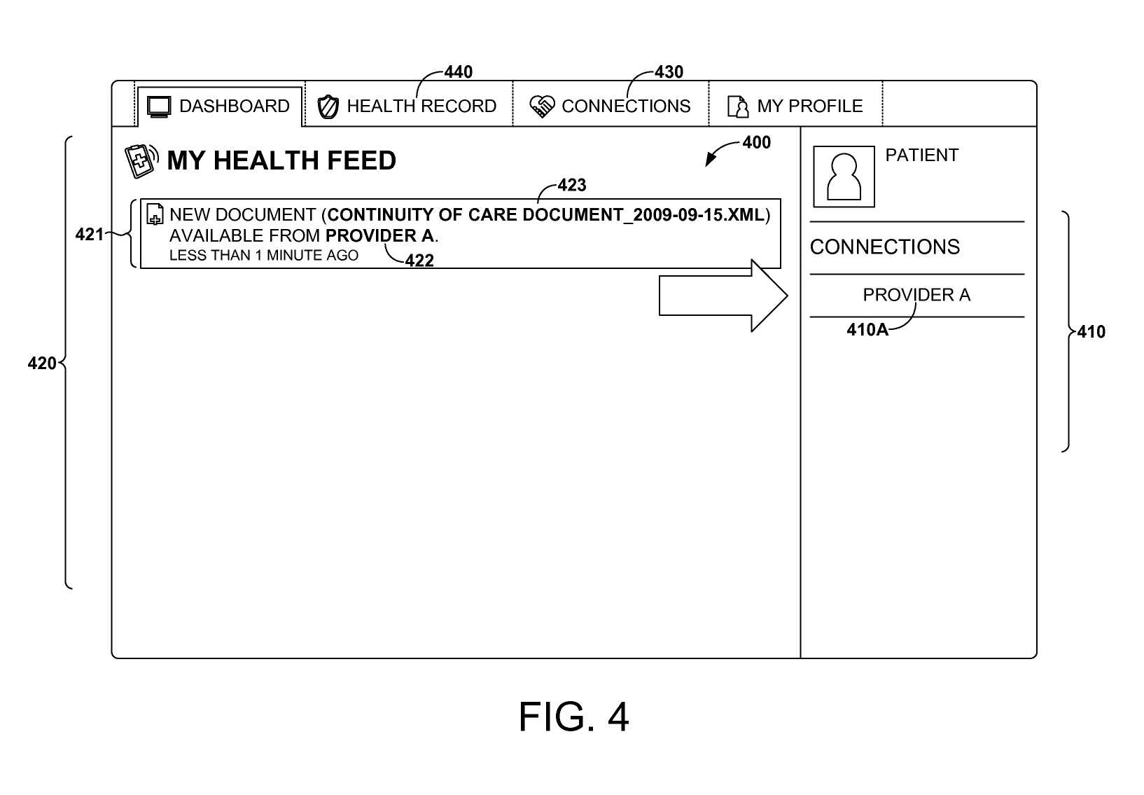

Turning now to FIG. 4, a graphical user interface (GUI) 400 illustrating a health record account summary page is provided. The GUI 400 includes a connection area 410 and a summary area 420. The connection area 410 is configured to display one or more providers that have a connection with the health record. For instance, a provider 410A of FIG. 4 is known to have a connection with the illustrated health record account. The provider 410A may be a selectable link such that selection thereof navigates a user to an information page associated with the provider 410A. Content of the information page associated with a provider may be customized by the provider and may include, but is not limited to, links to a provider's website, contact information for the provider, and the like. Providers having a connection with the health record account may also be displayed upon selection of a provider connection indicator 430.

The summary area 420 is configured to display notifications of new information added to the health record. For instance, a record indicator 421 indicates that a new document has been added to the health record. The record indicator 421 may include a selectable provider link 422 configured such that selection thereof navigates a user to the information page associated with the selected provider. The record indicator 421 may also include a selectable document link 423 configured such that selection thereof navigates a user to a document view.

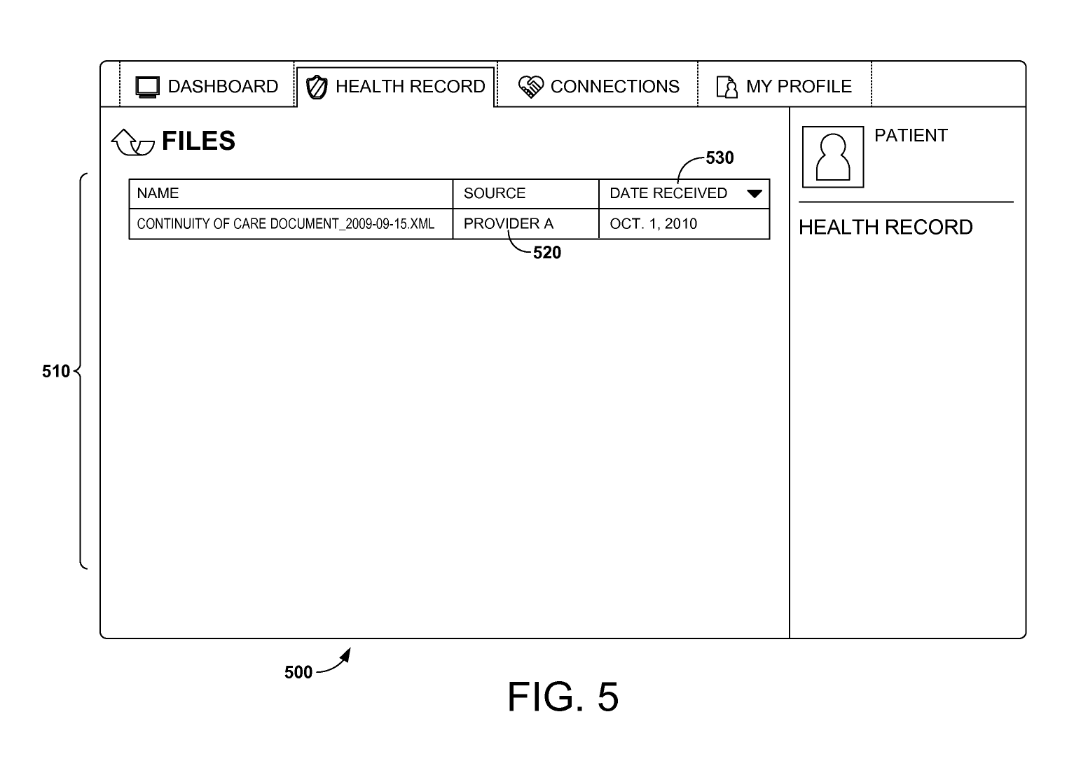

The GUI 400 also includes a selectable health record indicator 440 configured such that selection thereof navigates a user to a list of documents included in the health record illustrated in FIG. 5. FIG. 5 illustrates, in particular, a GUI 500 of a health record. The GUI 500 includes a document list area 510 that includes one or more patient documents that have been associated with the health record. Each record within the document list area 510 may be a selectable link such that selection thereof navigates a user to a view of the selected document. Additionally, each document within the document list area 510 may be associated with a selectable provider link 520 configured such that selection thereof navigates a user to the information page associated with the selected provider. The document list area 510 may also include a received area 530 that indicates a date that each document was associated with the health record.

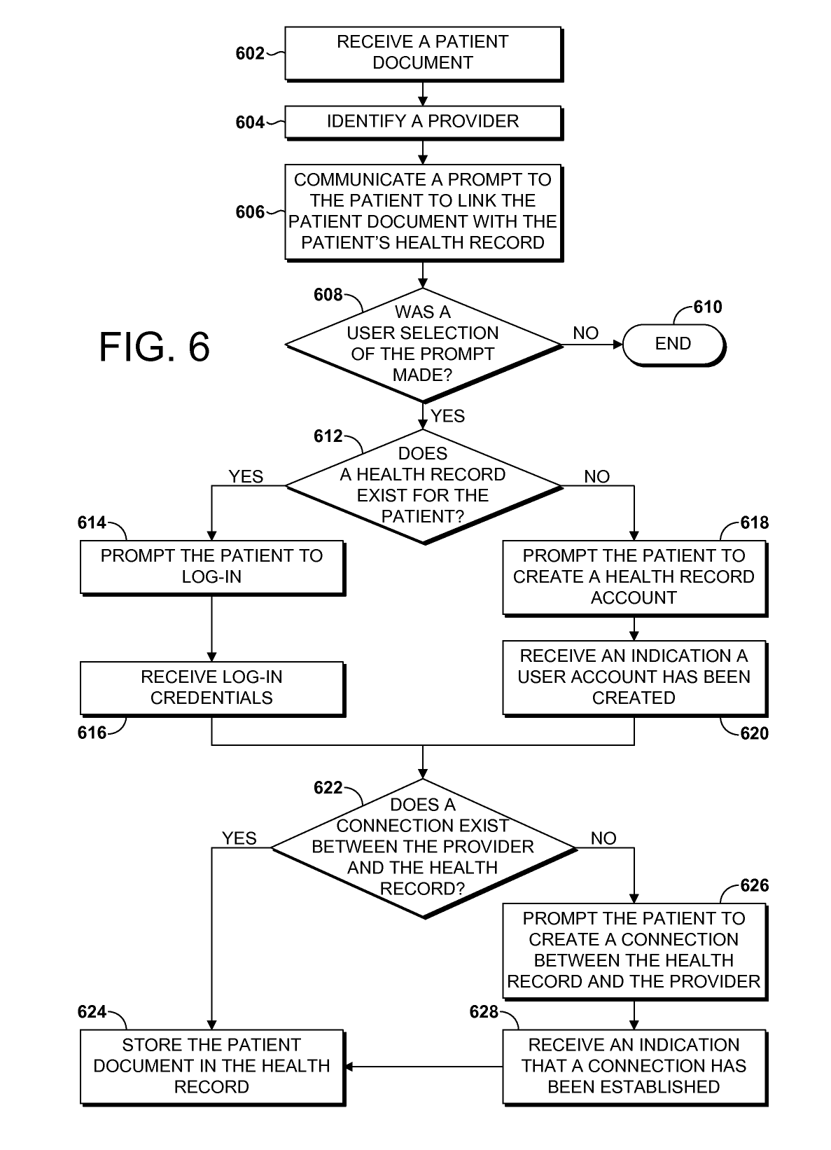

Referring to FIG. 6, a flow diagram showing a method 600 for linking health records, in accordance with an embodiment of the present invention, is provided. The method of FIG. 6 is from the perspective of a health record system, such as health record system 230 described in relation to FIG. 2. Initially, at step 602 a patient document is received. In embodiments, the patient document is a continuity of care document. The patient document may include patient data and clinical data. At step 604, a provider is identified that is associated with the patient document. A prompt is communicated requesting that a patient link the patient document with a health record account at step 606. At step 608 a determination is made whether a user selection of the prompt is received. If a user selection is not received, i.e., the user does not indicate that the patient document should be linked with a health record, the method ends at step 610. If a user selection of the prompt is received, the method proceeds to step 612.

At step 612, a determination is made whether a health record exists for the patient associated with the patient document. Upon determining a user health record does exist for the patient, a user is prompted to log-in to their existing health record account at step 614. Log-in credentials are received at step 616. Upon determining a user health record account does not exist for the patient, a user is prompted to create a health record account at step 618. At step 620 an indication is received that a health record account has been created.

Once log-in credentials are received for an existing health record account or a new health record account has been activated, a determination is made whether a connection exists between the provider and the health record account at step 622. If a connection between the provider and the health record exists, the method proceeds to step 624 and the patient document is associated with the health record. For example, once a user logs into their health record account, a patient document may be automatically associated with their health record account if a connection with the provider of the patient document has already been established.

Upon determining, at step 622, that a connection between the provider and the health record account does not exist, the method proceeds to step 626 and prompts the user to create a connection between the provider and their health record account. Once an indication that a connection has been created between the provider and the health record account is received at step 628, the patient document is stored in the health record at step 624.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. One or more computer storage media storing computer-useable instructions that, when used by one or more computing devices, cause the one or more computing devices to perform a method comprising:
receiving a patient document for a patient, wherein the patient document includes patient data and clinical data;
identifying a provider associated with the patient document;
communicating a prompt to the patient to verify the patient document;
receiving input from the patient;
determining that the patient input correlates with the patient data of the patient document; and
storing, utilizing a computing device, the patient document in a health record for the patient, wherein the health record for the patient includes at least one other patient document including documentation of another patient encounter.

2. The media of claim 1, wherein the at least one other patient document is associated with a second provider.

3. The media of claim 2, wherein the provider and the second provider are different healthcare providers.

4. The media of claim 1, wherein the patient data includes demographic information of the patient.

5. The media of claim 4, wherein the patient data includes the patient's name, the patient's date of birth, and the patient's postal zip code.

6. The media of claim 1, wherein the prompt is communicated to the patient based on patient contact information from the patient document.

7. The media of claim 6, wherein the patient contact information is an electronic mail address.

8. The media of claim 1, wherein the patient document is a continuity of care document for the patient encounter.

9. The media of claim 1, wherein clinical data is clinical documentation of a patient encounter.

10. The media of claim 1, further comprising:
determining whether a connection exists between the provider and the health record for the patient; and
upon determining that no connection exists between the provider and the health record for the patient, displaying a connection prompt to the patient to create the connection between the provider and the health record for the patient.

11. One or more computer storage media storing computer-useable instructions that, when used by one or more computing devices, cause the one or more computing devices to perform a method comprising:
receiving, for a patient, a patient document including patient data and clinical data;
identifying a provider associated with the patient document;
verifying the patient document, wherein verifying the patient document comprises:
(a) communicating a prompt to the patient to verify the patient document;
(b) receiving patient input including identifying information for the patient; and
(c) determining whether the patient input correlates with the patient data from the patient document;
upon determining that the identifying information from the patient input correlates with the patient data from the patient document, determining whether a connection exists between the provider and a health record of the patient associated with the patient document;
upon determining a connection does not exist between the provider and the patient's health record, establishing a connection between the provider and the patient's health record; and
storing, utilizing a computing device, the patient document in the patient's health record.

12. The media of claim 11, further comprising communicating the patient document to the patient's health record.

13. The media of claim 11, further comprising upon determining that a connection does exist between the provider and the patient's health record, automatically storing the patient document in the patient's health record.

14. The media of claim 11, wherein the patient data includes the patient's name and the patient's date of birth.

15. The media of claim 14, wherein the patient data further includes the patient's postal zip code.

16. The media of claim 11, wherein the prompt is communicated to the patient based on patient contact information from the patient document.

17. The media of claim 11, wherein the patient document is a continuity of care document for a single patient encounter.

18. One or more computer storage media storing computer-useable instructions that, when used by one or more computing devices, cause the one or more computing devices to perform a method comprising:
receiving, for a patient, a first patient document including patient data and clinical data;
identifying a first provider associated with the first patient document;
communicating a prompt to the patient to associate the first patient document with a health record for the patient;
receiving a first patient input;
determining whether a connection exists between the first provider and the health record for the patient;
upon determining a connection does not exist between the first provider and the patient's health record, establishing a connection between the first provider and the patient's health record;
storing, utilizing a computing device, the first patient document in the patient's health record;
receiving, for the patient, a second patient document including patient data;
identifying a second provider associated with the second patient document;
communicating a prompt to the patient to associate the second patient document with the health record for the patient;
receiving a second patient input;
determining whether a connection exists between the second provider and the patient's health record;
upon determining a connection does not exist between the second provider and the patient's health record, establishing a connection between the second provider and the patient's health record; and
storing, utilizing the computing device, the second patient document in the patient's health record such that the patient's health record includes both the first patient document and the second patient document.

19. The media of claim 18, wherein the first patient document is a continuity of care document.

20. The media of claim 18, further comprising:
identifying that the first patient input correlates with patient data from the first patient document; and
identifying that the second patient input correlates with patient data from the second patient document.
